(19) United States
(12) Patent Application Publication
(10) Pub. No.: US 2014/0351800 A1
(43) Pub. Date: Nov. 27, 2014

(54) Establishing Platform for If-This-Than-That Rule Based Application Program Used in Mobile Communication Device

(71) Applicant: EverMore Technology Inc., Hsinchu City (TW)

(72) Inventors: Jui-Chi JAO, Hsinchu City (TW); Ein-Paul WU, Hsinchu City (TW); Wu-Hsiung HUANG, Hsinchu City (TW); Feng-Chi YU, Hsinchu City (TW)

(73) Assignee: EVERMORE TECHNOLOGY INC., Hsinchu City (TW)

(21) Appl. No.: 14/283,738

(22) Filed: May 21, 2014

(30) Foreign Application Priority Data
May 22, 2013 (TW) 102118126

(51) Int. Cl. G06F 9/45

(52) U.S. Cl. CPC G06F 8/41
USPC 717/140

(57) ABSTRACT

The present invention relates to an application program establishing platform and a system of performing the same. The application program establishing platform, which is configured to be implementable on a computer to provide a user with a user interface for establishing an application program based on a user-defined logical determining criterion and implementable on a mobile device, includes: a managing module configured to provide the user to set the user-defined logical determining criterion, wherein the user-defined logical determining criterion is based on an if-this-than-that rule, and to compile the application program into a format implementable on the mobile device.

### FIELD

The present invention relates to an application program establishing platform and a system of performing the application program establishing platform. In particular, it relates to an establishing platform which allows any user to establish an application program based on a user-defined if-that-than-that rule by oneself.

### BACKGROUND

For recent years, with the prosperous developments of mobile technologies, the various mobile devices, such as a smart phone, a tablet computer, a phablet, a wearable device and so on, are rapidly improved and universalized. These various mobile devices respectively rely upon different operating systems (OSs) to drive, to arrange and to manage the typical operations in the device. There are several kinds of compilers corresponding to the respective operating systems provided for the general users, the ordinary consumers or the technical staff to encode or to compile the specific source codes executable under the specific operating system environment. The users can uses the compiler to program various application program (App), such as an entertainment game App, a finical App, a LBS service App, a communication App, a GPS-based App and so on, which are all executable on the mobile device.

However, as known to everyone, developing an App for running on the currently most popular Android smart phone is never to be an easy thing to do. The developer must get started from very initially and learn the Android SDK developing platform, the Eclipse developing environment, the Web related technologies and the Java syntax etc. Usually the developer must be a senior professional programmer. An ordinary user or consumer can never have an opportunity to develop one's own application program to run on a mobile device.

This is to say, in order to program an application program to execute on the mobile device, the developer must have quite professional capability and foundation regarding programming. For a minimum requirement, the developer shall understand the Html language, Java language, Android system and iOS system at least. Except the good programming capability, developing a successful application program further requires the very attractive digital contents. Therefore, to accomplish an application program is actually a laboring demanding task and also requires massive designs and plans. Hence, there needs a very convenience and simplified way to establish an application program. Especially there is a need to provide an ease way by which every ordinary user and general consumer can even establish the one's own application program, in particular to establish an IFTTT-based application program.

There is a need to solve the above deficiencies/issues.

### SUMMARY

The present invention provides an application program establishing platform. The application program establishing platform, which is configured to be implementable on a computer to provide a user with a user interface for establishing an application program based on a user-defined logical determining criterion and implementable on a mobile device, includes a managing module. The managing module is configured to provide the user to set the user-defined logical determining criterion, wherein the user-defined logical determining criterion is based on an if-this-than-that rule, and to compile the application program into a format implementable on the mobile device.

The present invention further provides a system of performing an application program establishing platform. The system of performing an application program establishing platform, by which system a user accesses the application program establishing platform having a user interface through a browser to establish an application program based on an if-this-than-that rule and implementable on a mobile device, includes a server and a user end. The server in which the application program establishing platform is installed is user for performing the application program. The user end is electrically connected to the server through an internet and capable of performing the browser, through which browser the user accesses the application program establishing platform, wherein the application program establishing platform comprises a managing module configured to provide the user to set up the if-this-than-that rule.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 shows a schematic diagram illustrating the essential system architecture in accordance with the present invention;

FIG. 2(a) shows a schematic diagram illustrating the editing area for the user interface provided by the IFTTT App establishing platform in accordance with the present invention;

FIG. 2(b) shows a schematic diagram illustrating the setting area for the user interface provided by the IFTTT App establishing platform in accordance with the present invention;

FIG. 3(a) shows a schematic diagram illustrating the IFTTT rule addition page provided by the IFTTT App establishing platform in accordance with the present invention;

FIG. 3(b) shows a schematic diagram illustrating the IFTTT rule addition page provided by the IFTTT App establishing platform in accordance with the present invention;

FIG. 4(a) shows a schematic diagram illustrating the IFTTT rule addition page provided by the IFTTT App establishing platform in accordance with the present invention;

FIG. 4(b) shows a schematic diagram illustrating the IFTTT rule addition page provided by the IFTTT App establishing platform in accordance with the present invention;

FIG. 4(c) shows a schematic diagram illustrating the IFTTT rule addition page provided by the IFTTT App establishing platform in accordance with the present invention;

FIG. 4(d) shows a schematic diagram illustrating the IFTTT rule addition page provided by the IFTTT App establishing platform in accordance with the present invention;

FIG. 5 shows a schematic diagram illustrating the button data medication page provided by the IFTTT App establishing platform in accordance with the present invention;

FIG. 6 shows a schematic diagram illustrating the front page for the IFTTT App established by the IFTTT App establishing platform in accordance with the present invention;

FIG. 7 shows a schematic diagram illustrating the control interface for the external device on the IFTTT App established by the IFTTT App establishing platform in accordance with the present invention;

FIG. 8 shows a schematic diagram illustrating the IFTTT rule addition page provided by the IFTTT App establishing platform in accordance with the present invention;

FIG. 9 shows a schematic diagram illustrating the IFTTT rule addition page provided by the IFTTT App establishing platform in accordance with the present invention;

FIG. 10 shows a schematic diagram illustrating the IFTTT rule addition page provided by the IFTTT App establishing platform in accordance with the present invention; and

FIG. 11 shows a schematic diagram illustrating the user-defined template configuration page provided by the IFTTT App establishing platform in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

The computer described in the present disclosure is preferably a personal computer, a desktop computer or notebook computer, the mobile device described in the present disclosure is preferably a smart phone, a tablet computer or a phablet (a.k.a. a tablet phone), the internet described in the present disclosure is preferably a cable network, a wireless network, a cloud network, a local area network (LAN) or a wide area network (WAN), and the application program described in the present disclosure is hereinafter referred to as App for short, which App is a program implementable through the aforementioned mobile device. For the sake of describing the present invention simply and definitely, the aforementioned computer is to be exemplarily described with respect to but not limited to a desktop computer and the aforementioned mobile device is to be exemplarily described with respect to but not limited to a smart phone.

The present invention requires the uses of the cloud networks related services and technologies, such as a software as a service (SaaS) technology, a platform as a service (PaaS) technology and an infrastructure as a service (IaaS) technology etc. A service provider refers to an entity in responsible to design, develop, manage or maintain an application program establishing platform described in the present disclosure and in accordance with the present invention. The App in the present disclosure is an application program related to and based on the geographic information system (GIS) technology, the global positioning system (GPS) technology and the location based services (LBS) technology and can show the geographic-based contents including the GIS-related information, the GPS-related information and the LBS-related information, which is capable of rendering users to quickly understand the geographic-based information regarding the area where she/he currently stays.

It is to be noticed that the present disclosure includes contents in Taiwan patent application number 100126878, entitled as “Method of Providing Contents for Mobile Computing Device” and filed on 28 Jul. 2011, contents in Taiwan patent application number 101102719, entitled as “Method of Establishing Community Application Program for Mobile Computing Device” and filed on 20 Jan. 2012, contents in Taiwan patent application number 101115678, entitled as “System and Method of Establishing Application Program for Mobile Computing Device” and filed on 2 May 2012 and contents in Taiwan patent application number 101123945, entitled as “Establishing System and Method for Establishing Application Program for Mobile Computing Device and Having Capability Controlling Input and Output Interface” and filed on 3 Jul. 2012, which above-identified applications have the Applicants the same as the present invention does and are incorporated into this application by reference as if fully set forth herein.

Syntax IFTTT (IF This Then That) is typically referred to as a conditional selection structure which is a basic and necessary syntax in all kinds of the computer program language. The IFTTT syntax is also regarded as a condition-triggered automation tool, which means that if a triggering event, a specific event, a specific input or a stimulation occurs, then a responding task, a specific response, a specific task or a specific action is triggered, activated, started or enabled in response thereto. A complete IFTTT syntax including the this part (the triggering event) and the that part (the responding task) also refers to as an IFTTT rule or an IFTTT recipe.

Accordingly, the present invention proposes a cloud technology-based establishing platform which allows an ordinary user or a general consumer to be able to establish an IFTTT-based application program including a user-defined IFTTT rule and executable on a mobile device by oneself. The IFTTT application is an if-this-then-that automation tool, which is also known as “an automatic task”, “a logical determination” or “a condition-trigger-response determination”. The establishing platform further combines the input/output interface control technology, so that an ordinary user or a general consumer can even establish an application program having the capability to remotely control an external device separated from the mobile device.

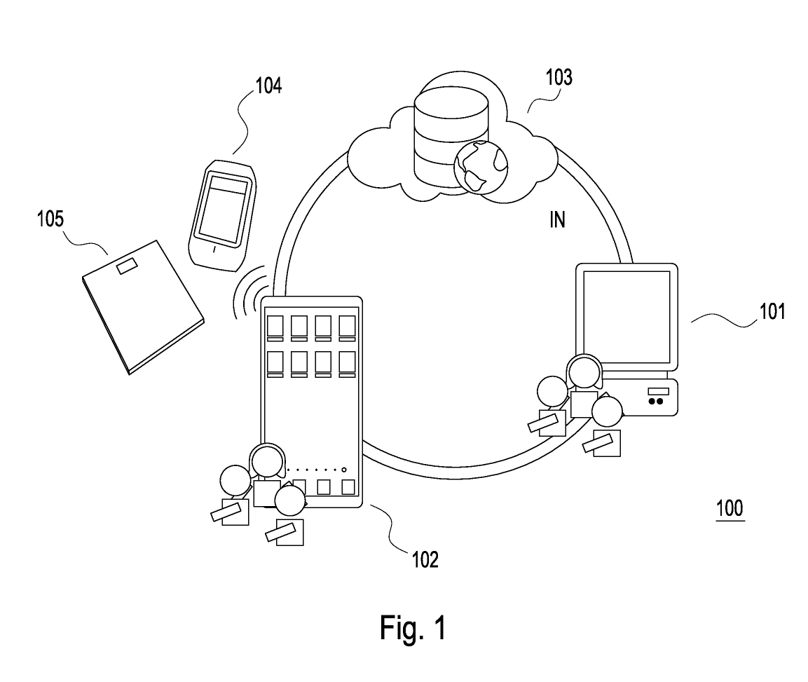

FIG. 1 shows a schematic diagram illustrating an essential system architecture in accordance with the present invention. The system assembly 100 as shown in FIG. 1 includes a computer 101, a mobile device 102 and a server 103, which are electrically connected with each other through an internet including multiple networks selected from a cable network, a wireless network, a cloud network, a local area network (LAN) or a wide area network (WAN) and a combination thereof, in order to communicate with each other and to exchange data and information with each other. The computer 101 is preferably a personal computer, a desktop computer or notebook computer. The mobile device 102 is preferably a smart phone, a tablet computer or a phablet (a.k.a. a tablet phone). The mobile device 102 can communicate with an external device, such as a weighing scale 104 and an oximeter 105, by a wireless communication module, such as a Wi-Fi wireless communication module and a Bluetooth communication module.

For a smart phone, the mobile device 102 includes an application processor, a wireless communication module, a display module, multiple functional modules, multiple sensor modules and so on, wherein the wireless communication module is preferably one selected from a wireless signal power amplifier chip, a radio frequency chip and a combination thereof, the multiple functional modules are preferably one of an audio encoding/decoding chip, a memory chip, power management chip, battery management chip and so on, and the multiple sensor modules are preferably one of a motion sensor chip, an acceleration sensor, a magnetic sensor, an infrared ray emission LED, a front image sensor, a rear image sensor, a luminance sensor, a touch-sensed chip, a GPS signal sensor, a proximity sensor, a temperature sensor, a counter sensor, a timer and so on.

The wireless communication module in the mobile device 102 is used for receiving or transmitting a wireless signal from or to a base station. Each of the multiple sensor modules is used for sensing a specific event, generating a sensing signal corresponding to the specific event and sending the sensing signal to the application processor. An IFTTT-based application program in accordance with the present invention is installed in the application processor. After the application processor receives the sensing signal, the IFTTT application program performs a user-defined logical determining criterion including a user-defined condition. The program then determines whether the sensing signal satisfies the user-defined condition based on the criterion, and if the sensing signal meets the user-defined condition, the application processor is then triggered to perform a specific task in response to the specific event, to complete the entire IFTTT-based operation.

It is to be noticed that the IFTTT-based App includes an I/O control functional subroutine to enable the mobile device to communicate with an external device in bi-direction by Wi-Fi or Bluetooth wireless communication technology, wherein the external device is preferably one of a weighing scale 104, an oximeter 105, a remote control vehicle, a camera and so on, whereby the mobile device is allowed to control the external device through the I/O interfaces in the mobile device by the I/O control functional subroutine in the IFTTT-based App, which technology is fully disclosed in Taiwan patent application number 101123945 which is fully incorporated into this application by reference as if set forth herein.

Thus, the mobile device, for example, a smart phone preferably, is to be a very smart phone based on the user-defined “if-this-then-that” rule. For example, a user can define to enable several beep sounds when the smart phone approaches to a predetermined location, to trigger the flashlight or the camera when the smart phone is moved or shook or to active the camera at a specific time on a specific date and so on. Therefore, any smart phone to be installed with such IFTTT-based App can serve a user better as a smart assistance, a smart notificationer, a smart sound maker or a smart motion sensor etc. In the present invention, it is capable of rendering any user to autonomously set up this IFTTT-based App by oneself by an App establishing platform. Any user can define a triggering event, a responding task in correspondent to or in response to the triggering event and various parameters in an IFTTT rule by one self through simply operating the App establishing platform. The platform then complies and packs the user-defined condition for IFTTT rule as an App implementable on the mobile device, so that any user can create an IFTTT-based App implementable on a mobile device in accordance with to the IFTTT rules of one's own, so as to achieve a customized IFTTT-based App.

The IFTTT-based App establishing platform (hereinafter termed as “platform” for short) is installed on the server 103. The platform is an App generator based on such as PaaS technology and is designed, developed, managed and maintained by a service provider. The platform opens the IFTTT conditions regarding the triggering event, the responding tasks and various IFTTT parameters to any user and provides a simple option form which provides any user to set up the conditions simply through filling and selecting the form in a convenience and easy way, so as to set up the IFTTT rules of one's own by the user. After the user completes the form, the platform complies, programs, packs and encodes an App including these conditions including the triggering event, the responding tasks and various IFTTT parameters to become as an application program executable on the mobile device. For example, for an android system, the platform can establish the .apk app. The user can then install this App on the mobile device to perform the IFTTT missions. By this way, any user or an ordinary consumer can easily, simply and quickly make an IFTTT-based App in accordance with demands of one's own. The platform involves the technologies disclosed in TW patent application number 100038225, TW patent application number 101102719, TW patent application number 101115678 and TW patent application number 101123945, which are fully incorporated into this application by reference as if fully set forth herein.

### The First Embodiment

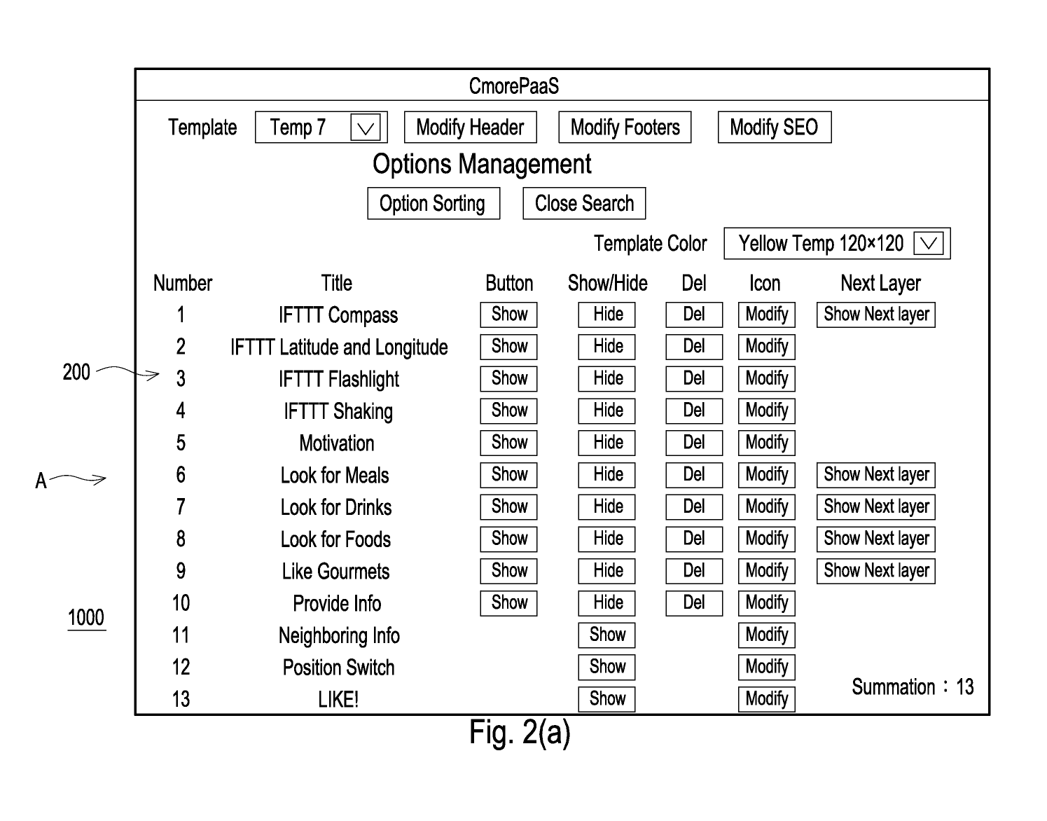

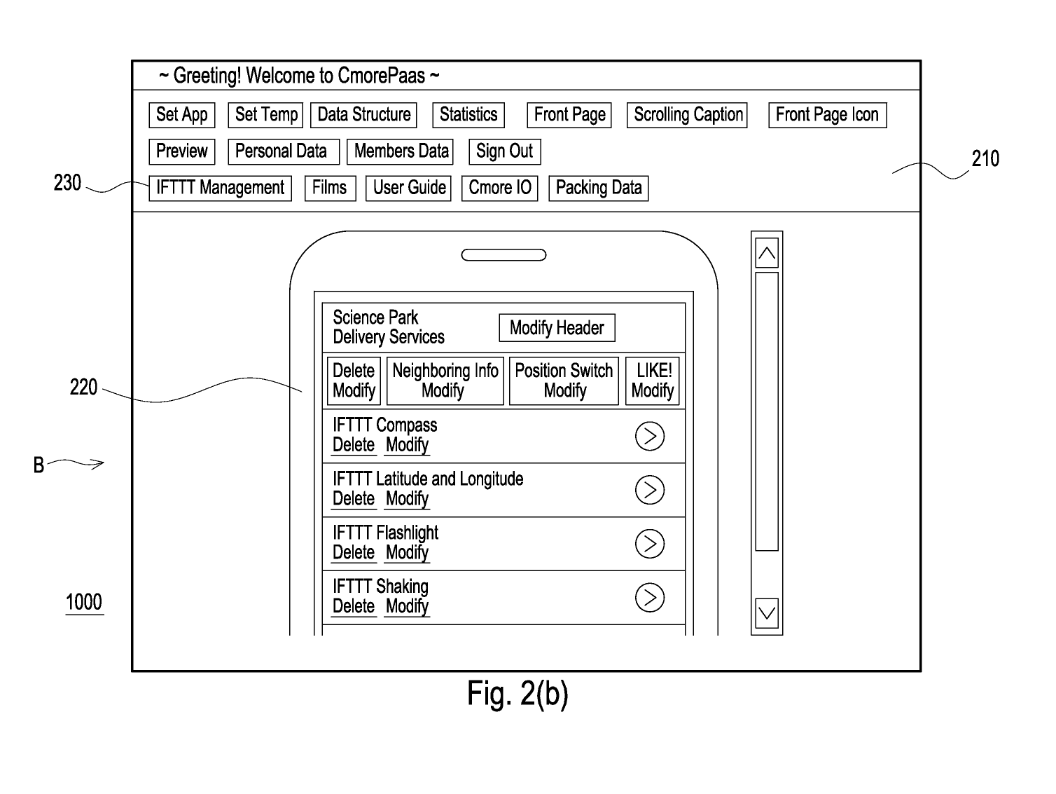

This embodiment is used for describing the IFTTT App for mobile device and the IFTTT App establishing platform thereof. FIG. 2(a) and FIG. 2(b) show schematic diagrams illustrating a user interface provided by the IFTTT App establishing platform in accordance with the present invention. The user interface (UI) 1000 includes two parties which are an editing area A as show in FIG. 2(a) and a setting area B as shown in FIG. 2(b). As shown in FIG. 2(a), the top layer in the editing area A includes an options management page 200 which also acts as a front page for the editing area A. As shown in FIG. 2(b), the top layer in the setting area B includes a functional area 210 and a simulation area 220 for a smart phone. Any user can set up the options and templates on a mobile phone via the editing area A and instantly review the result regarding the set options and templates to be presented on the screen of the smart phone by directly observing the simulation area 220. The simulation area 220 synchronically demonstrates a simulated scene regarding the screen of the smart phone which is in accordance with the set options and templates through the functional area 210 by the user.

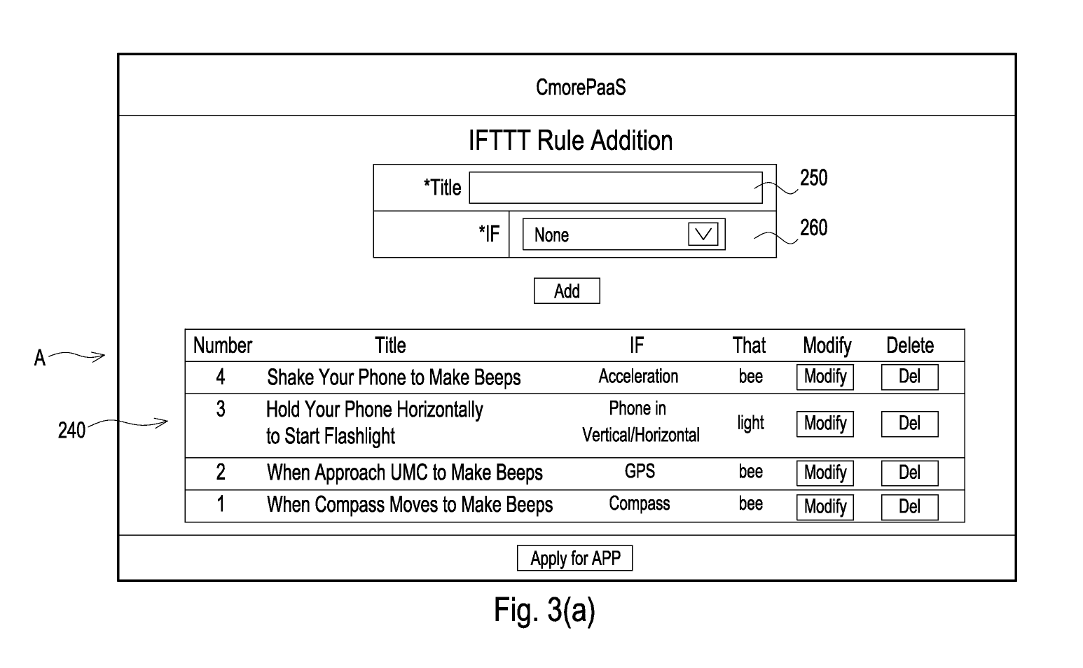

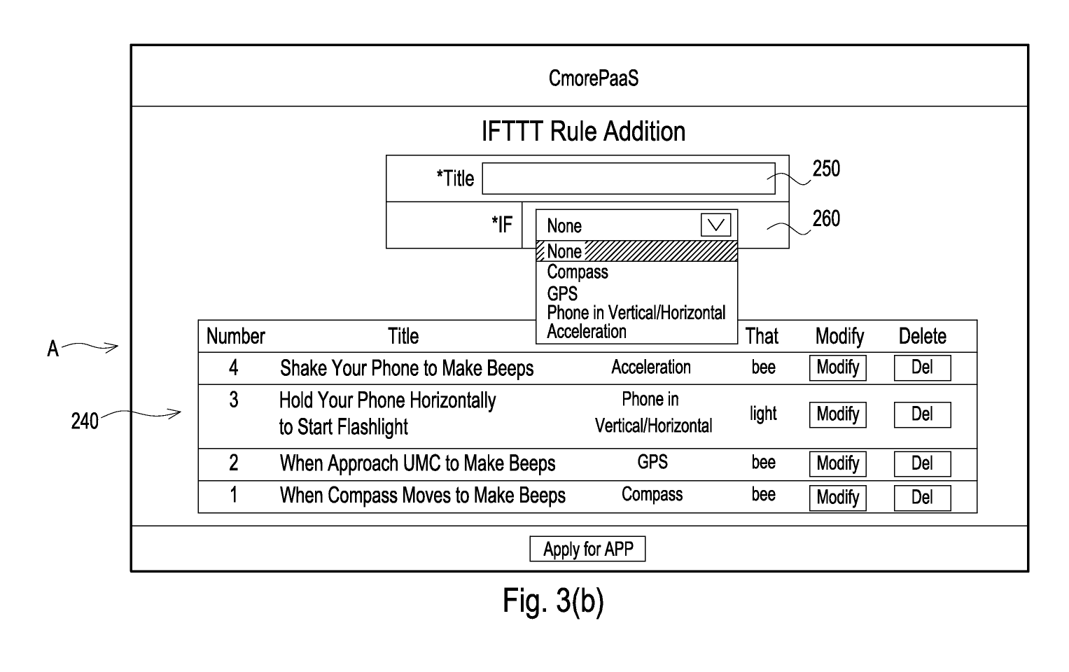

During operating, when the user successfully logs into the establishing platform, she/he can click the IFTTT management button 230 situated in the upper left corner in the functional area 210 within the setting area B. After clicking, the user enters an IFTTT rule addition page 240 which is shown in the editing area A as shown in FIGS. 3(a) and 3(b) to replace the options management page 200 in the editing area A.

In the first embodiment, the IFTTT rule addition page 240 as shown in FIGS. 3(a) and 3(b) already includes four counts of predetermined IFTTT rule templates, which respectively have different titles, such as “Shake Your Phone to Make Beeps”, “Hold Your Phone Horizontally to Start Flashlight”, “When Approach UMC to Make Beeps” and “When Compass Moves to Make Beeps” etc. In the rule “Shake Your Phone to Make Beeps”, the smart phone is set to perform a responding task as making several beep sounds in response to a triggering event as shaking smart phone, which is an acceleration event. That is, if the sensed acceleration exceeds over a certain threshold or a certain condition, it is triggered to make several beeps sounds. In the rule “Hold Your Phone Horizontally to Start Flashlight”, the smart phone is set to performing a responding task as activating the flashlight in response to a triggering event as detecting the phone to be put in horizontal. That is if the sensed posture of the smart phone is in horizontal, it is triggered to activate the flashlight. In the rule “When Approach UMC to Make Beeps”, it has a triggering event as approaching a specific location and a responding task as making several beep sounds. In the rule “When Compass Moves to Make Beeps”, it has a triggering event as detecting the movement of the magnetic sensor and a responding task as making several beep sounds. Therefore, in FIG. 3(a) and FIG. 3(b), the triggering event is to be set through the IF column and the responding task is to be set through the That column.

If a user wants to newly add an IFTTT rule, the addition process can be completed through operating the IFTTT rule addition page 240. First the user specifies an appropriate title to represent the IFTTT rule and input it into the Title field 250 in the IFTTT rule addition page 240. Then the user clicks the IF pull-down menus 260 to select a triggering event to be detected. In this embodiment, there are four triggering events provided to the user to be exemplarily described with respect to but not limited to a compass-based triggering event, a GPS-based triggering event, a posture-based triggering event and an acceleration-based triggering event.

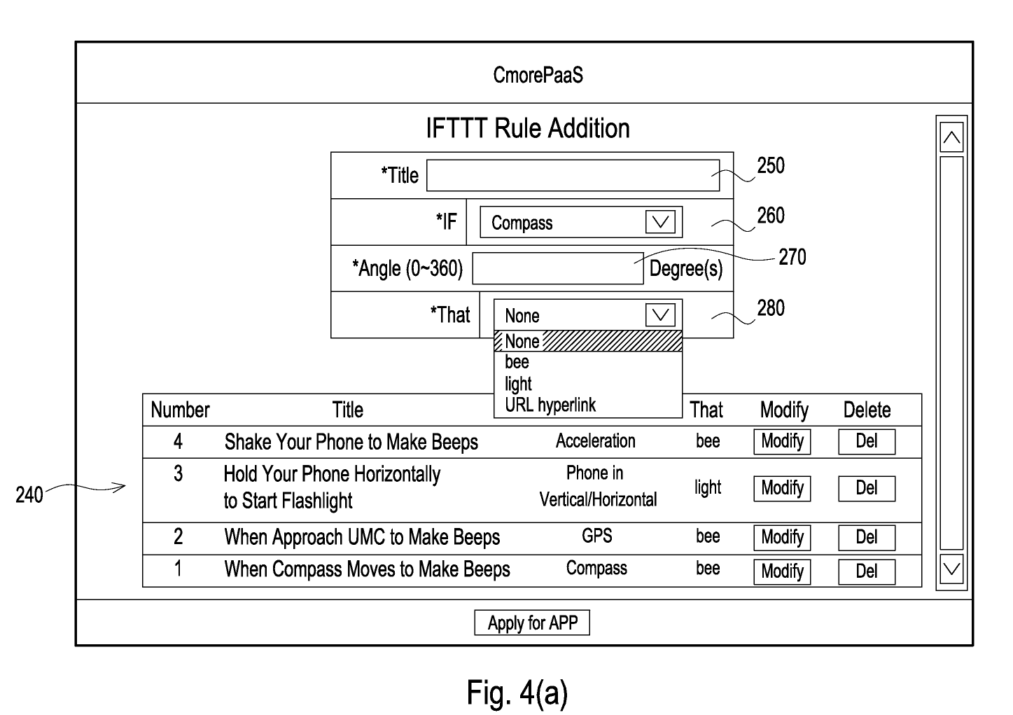

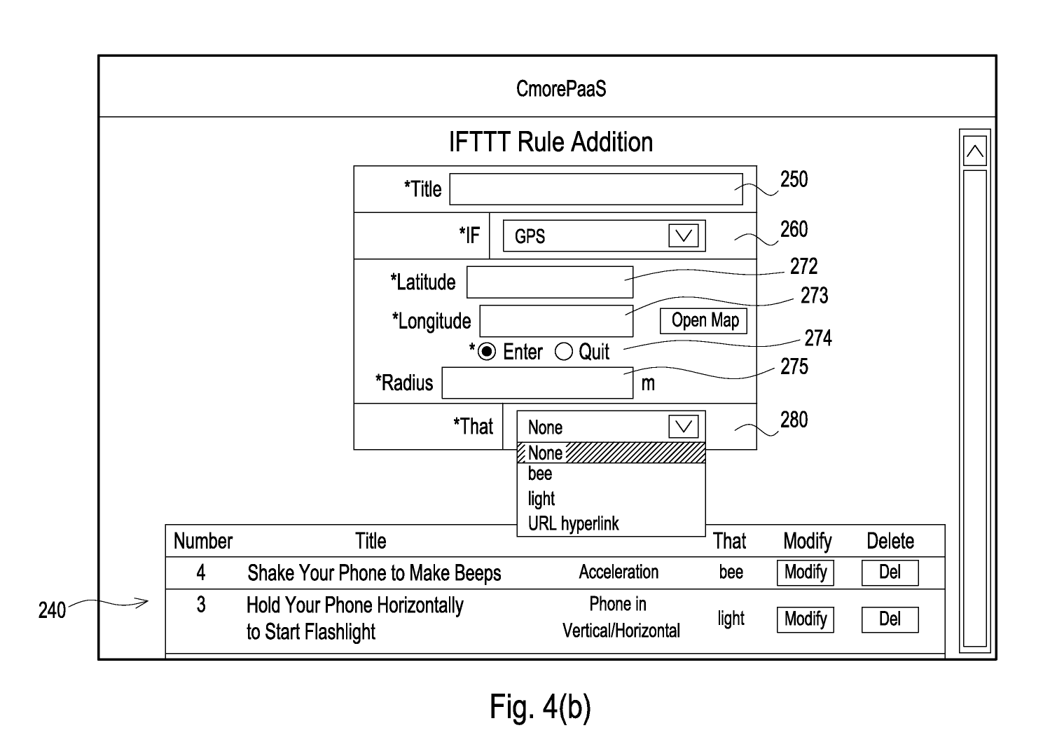

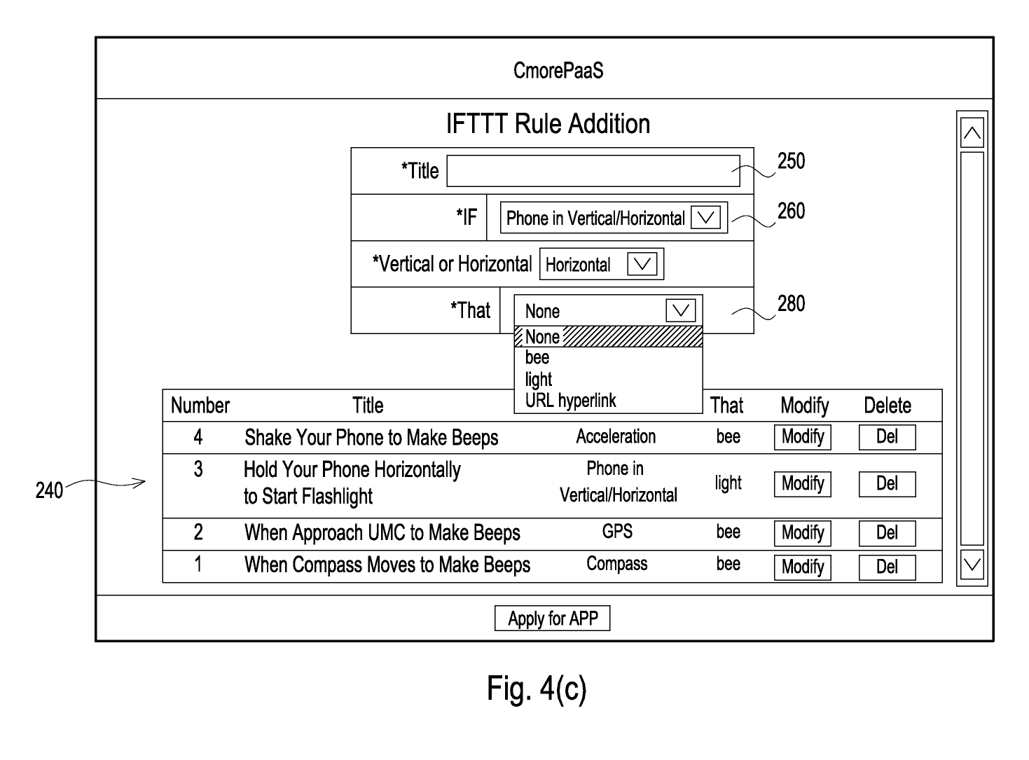

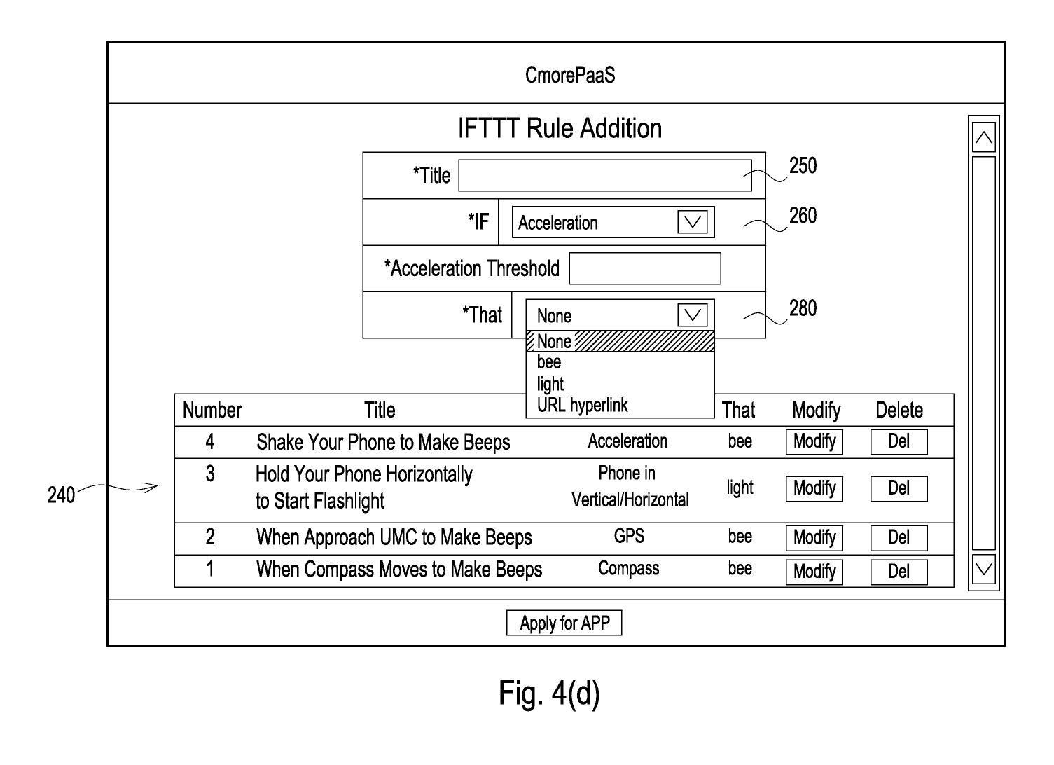

As shown in FIG. 4(a), it is assumed that the user selects the compass-based triggering event in the IF pull-down menus 260. Next an angle field 270 (in a range between 0˜360 degrees) appears which field provides the user to fill in a threshold angle for the compass-based triggering event and a That pull-down menus field 280 appears which filed provides the user to fill in the responding task in response to the triggering event in the IFTTT rule addition page 240. In this embodiment, there are three responding tasks provided to the user to be exemplarily described with respect to but not limited to a responding task as making several beep sounds, a responding task as activating a flashlight and a responding task as link to a specific URL hyperlink address. As described in the aforementioned disclosure, when the IFTTT-based App combines an I/O control functional subroutine, as to the responding tasks the IFTTT-based App allows the user to set up an IFTTT rule including a responding task to further control an external device in response to the triggering event, and as to the triggering events the IFTTT-based App allows the user to set up an IFTTT rule to receive a sensed signal from an external device as an triggering event.

If the compass-based triggering event is selected in the IF pull-down menus 260 and an angle representing the North direction is filled into the angle field 270, when the smart phone is oriented toward the North direction, the smart phone is capable of making several beep sounds, activating a flashlight or linking to a URL hyperlink address, in response to the orientation of the smart phone.

As shown in FIG. 4(b), it is assumed that the user selects the GPS-based triggering event in the IF pull-down menus 260. Next, a Latitude field 272, a Longitude field 273, a status field 274 and a Radius field 275 appear in the IFTTT rule addition page 240 for providing the user to fill in triggering parameters with respect to the latitude, the longitude, the status and the radius data respectively. A That pull-down menus field 280 also appears in the IFTTT rule addition page 240 for providing the user to select a responding task. In this embodiment, there are three responding tasks provided to the user to be exemplarily described with respect to but not limited to a responding task as making several beep sounds, a responding task as activating a flashlight and a responding task as link to a specific URL hyperlink address. As described in the aforementioned disclosure, when the IFTTT-based App combines an I/O control functional subroutine, as to the responding tasks the IFTTT-based App allows the user to set up an IFTTT rule including a responding task to further control an external device in response to the triggering event, and as to the triggering events the IFTTT-based App allows the user to set up an IFTTT rule to receive a sensed signal from an external device as an triggering event.

According to the GPS-based IFTTT rule, when the smart phone enters into or quits a specific radius based on the inputted latitude and longitude as a center point, the responding tasks such as making several beep sounds, activating a flashlight or linking to an URL hyperlink is to be performed if the triggering event occurs.

As shown in FIG. 4(c), if the user selects to set up a posture-based triggering event IFTTT rule, when the defined posture is detected, the pre-selected corresponding task (making beep sounds, enabling a flashlight or linking to an URL hyperlink) is to be executed in response to the triggering event. As shown in FIG. 4(d), if the user selects to set up a shaking-sensed triggering event IFTTT rule, when the shacking is detected, the pre-selected corresponding task (making beep sounds, enabling a flashlight or linking to an URL hyperlink) is to be executed in response to the triggering event.

When the user completes the configurations for the IFTTT rule, if the user returns to the editing area A in the options management page 200 as shown in FIG. 2(a), she/he can see that every IFTTT rules that she/he establishes are shown with the specified title.

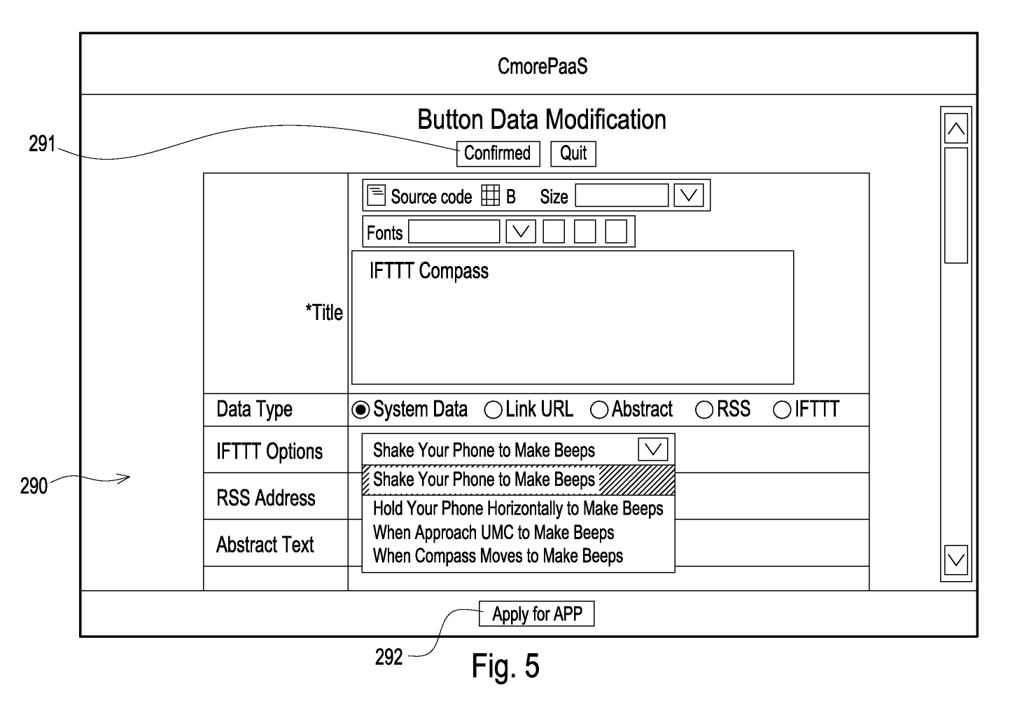

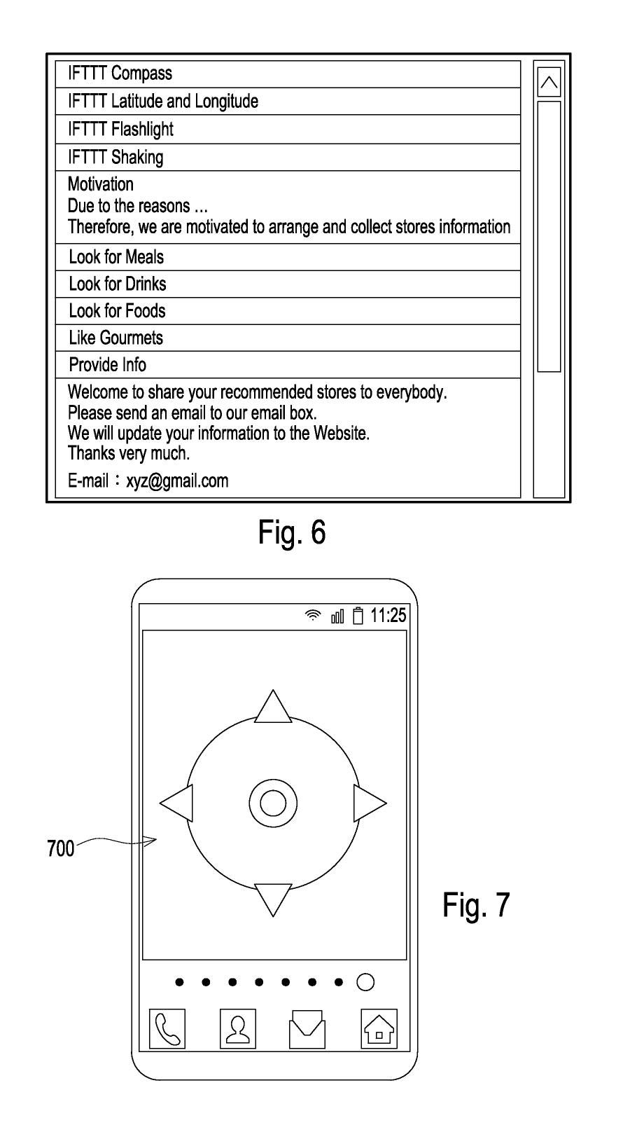

Consequently, the user can further click the Modify Icon following with the corresponding IFTTT rule to enter a button data modification page 290 as shown in FIG. 5 to further modify or set the details for the corresponding IFTTT rule and the web pages thereof. As shown in FIG. 5, the user can follows the instructions shown on the button data modification page 290 to further set details such as Fonts, RSS address and Data Type etc. Once the user finishes the configurations, she/he can click the Confirmed button 291 to confirm the whole configurations. Then the user presses the button Apply for App 292 to instruct the establishing platform to enable the compiling process, the transforming process and the packing process for the several set IFTTT rules as a file executable on the mobile device (such as a .apk file executable on Android-based mobile device). The user then installs the executable file on the mobile device and enters into the front page for the IFTTT App, which is shown in FIG. 6.

### The Second Embodiment

In the second embodiment, the above-mentioned I/O control technology which is realized through an I/O control functional subroutine is now integrated and combined into the application program establishing platform, so as to generate an IFTTT-based App capable of controlling an external device. An Arduino SoC (system on chip) remote control toy car preferably acts as an external device in this second embodiment. A standard Bluetooth wireless communication protocol is preferably adopted as the I/O communication interface between the mobile device and the external device. If user installs the IFTTT-based App on the mobile device, she/he can remotely control the toy car through the App installed on the mobile device. As shown in FIG. 7, a finished IFTTT App for remotely controlling the toy car has a control interface 700 in FIG. 7. There are a moving forward arrow, a moving backward arrow, a turning left arrow, a turning right arrow and a stop button in circular form arranged in the control interface 700. Once the user presses each icon, the toy car activates the action in correspondent to the respective icons.

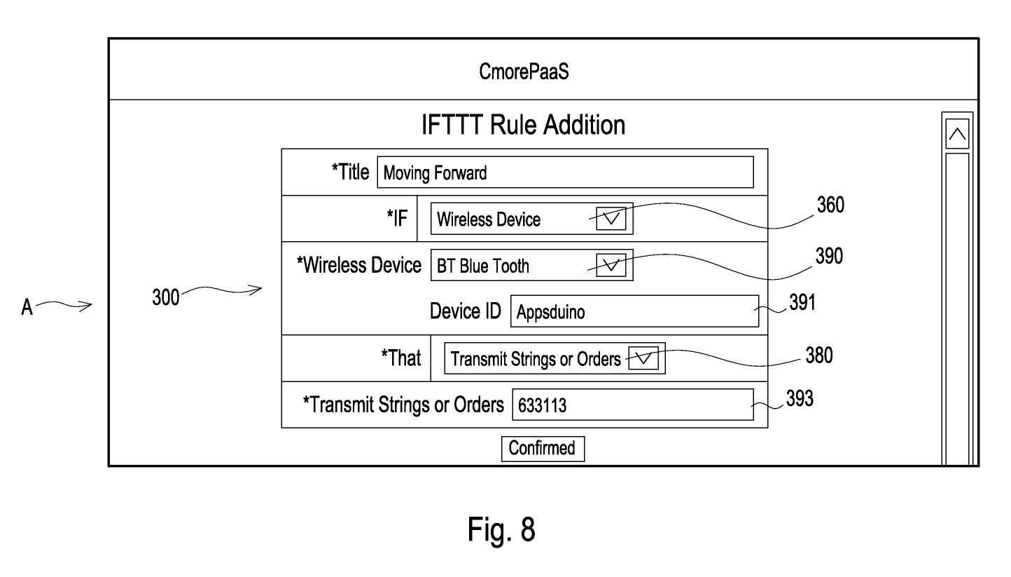

The second embodiment is used for describing the integration and combination of the above-mentioned I/O control technology with the present application program establishing platform in order to further control an external device. In following with the above-mentioned descriptions to FIGS. 3(a) and 3(b) and FIGS. 4(a), 4(b), 4(c) and 4(d), FIG. 8 shows an IFTTT Rule Addition page 300 with several additional fields for the external device in the editing area A. In comparison with the IFTTT Rule Addition pages 240 in the respective FIGS. 3(a), 3(b), 4(a), 4(b), 4(c) and 4(d), the IFTTT Rule Addition page 300 in FIG. 8 is additionally added with several fields such as a Wireless Device pull-down menus 390 and a Device ID field 391 for the external device. Furthermore, in the IF pull-down menus 360 and the That pull-down menus 380, some additional options with respect to select and set the external device are newly added therein, which allows the user to set up the input signal from the external device as the triggering event or the responding task respectively.

In the IFTTT Rule Addition page 300, a “wireless device” option is additionally included in the IF pull-down menus 360. First, the user selects the “wireless device” option in the IF pull-down menus 360 and next selects the wireless communication protocol intended to use, such as a Wi-Fi protocol or a Bluetooth protocol, through the Wireless Device pull-down menus 390. In this embodiment, a Bluetooth protocol is preferably selected as the wireless communication protocol. Then the user inputs the specific ID for the external device in the Device ID field 391. It is assumed that the specific ID for the external device is Appsduino, and then the character string “Appsduino” is inputted into the Device ID field 391. Then the user selects the “Transmit Strings or Orders” option in the That pull-down menus 380 and inputs the strings or orders into the Transmit Strings or Orders field 393. In this embodiment, since the Arduino SoC accepts orders from the Arduino open source code which consists of a series of umbers, the Arduino order 633113 for representing moving forward is inputted into the Transmit Strings or Orders field 393. Therefore, an IFTTT rule that a corresponding task to instruct the toy car to move forward is activated when any user touches the moving forward arrow shown on the control interface 700 is generated.

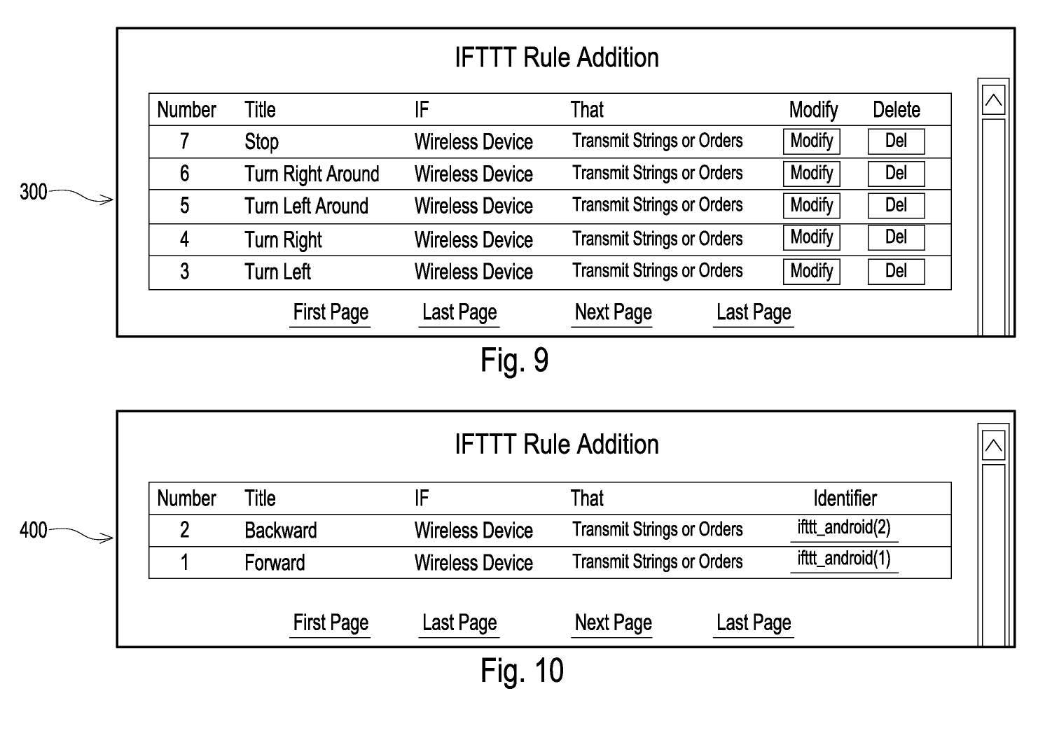

By the same token, multiple IFTTT rules regarding controlling the external device, such as the toy car, to move backward, to turn right, to turn left and to stop are generated. In the mean time, there are multiple titles for the above-mentioned IFTTT rules newly appearing in the IFTTT Rule Addition page 300 in the editing area A, as shown in FIG. 9. The user can click the modify button in the IFTTT Rule Addition page 300 in FIG. 9 to further specify an identifier name corresponding to the inputted strings or orders, which identifier also provides a mapping relationship between the IFTTT rule and the operating system on the mobile device. FIG. 10 shows the Identifier field in the IFTTT Rule Addition page 300. In FIG. 10, the user specifies identifier names as ifttt_android(2) and ifttt_android(1) for the Backward IFTTT rule and the Forward IFTTT rule respectively in the Identifier field in the IFTTT Rule Addition page 300. Further information regarding the above-mentioned I/O control technology can be referred to Taiwan patent application number 101123945, which is incorporated into this application by reference as if fully set forth herein.

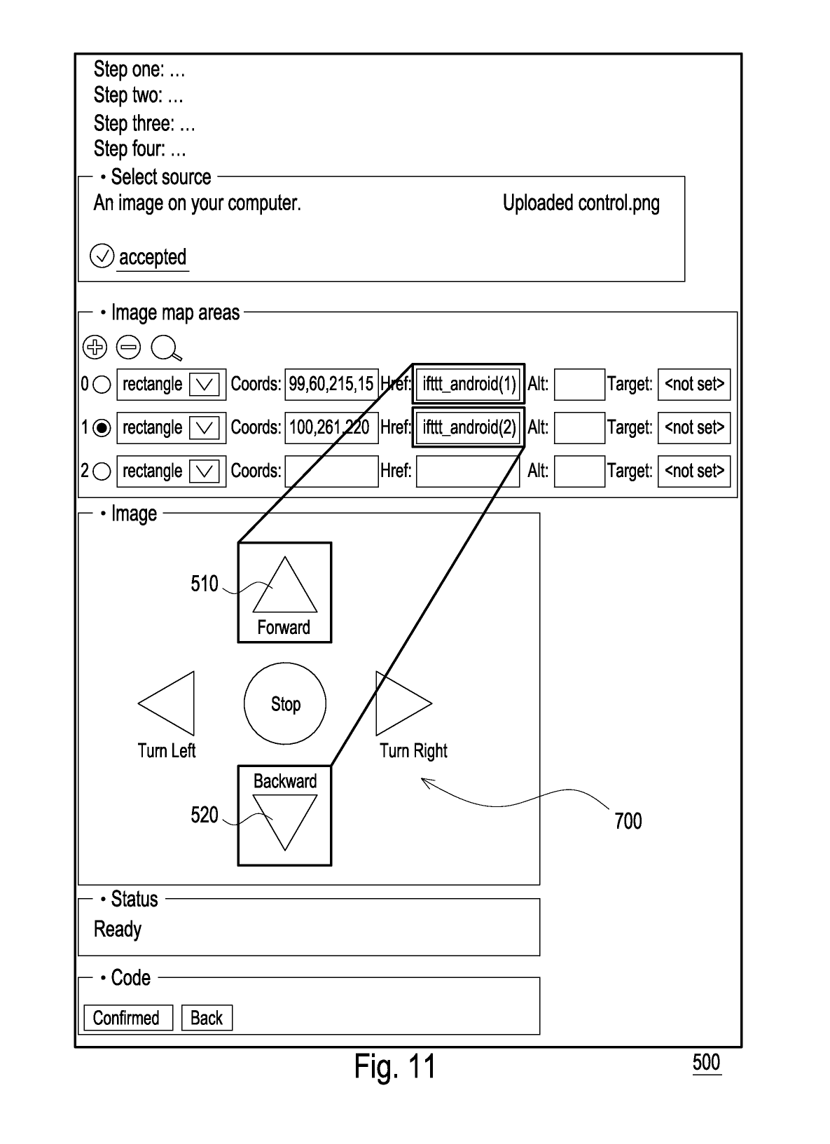

FIG. 11 shows a user-defined template configuration page 500 in accordance with the present invention. Through operating this user-defined configuration page 500, the control interface 700 demonstrated in the image block in the user-defined configuration page 500 is a user-defined image or picture that is pre-made and then uploaded to the present establishing platform by the user. The control interface 700 in the user-defined configuration page 500 is the same with the control interface 700 used in FIG. 7. The user can design or use other image else to be the control interface 700, which is not limited to the present image.

Then the user drags the mouse to select a box area which entirely covers the forward triangle symbol, namely the neighboring area around the forward triangle button 510. At the mean time, the Coords field in the first row in the image map area block shows the corner coordinates for the selected box area, which are (99, 60, 215, 150) in this second embodiment. Then the user fills the identifier name representing moving forward into the Href field in the first row, which is ifttt_android(1) in this second embodiment. Similarly, the user drags the mouse to select a box area which entirely covers the backward triangle symbol, namely the neighboring area around the backward triangle button 520. At this time, the Coords field in the second row in the image map area block shows the corner coordinates for the selected box area, which are (100, 261, 220, 351) in this second embodiment. Then the user fills the identifier name representing moving forward into the Href field in the second row, which is ifttt_android(2) in this second embodiment. Accordingly, the character strings ifttt_android(1) representing moving forward is to be mapped to the area within the coordinates set (99, 60, 215, 150) and the character strings ifttt_android(2) representing moving backward is to be mapped to the area within the coordinates set (100, 261, 220, 351). Therefore, as the user touch the area within the coordinates set (99, 60, 215, 150) representing the forward triangle button, this touch event is regarded as a triggering event and then the predetermined action (to drive the toy car to move forward, namely the corresponding task) set by the character strings ifttt_android(1) is activated or enabled to drive the toy car to move forward. Similarly, as the user touch the area within the coordinates set (100, 261, 220, 351) representing the backward triangle button, this touch event is regarded as a triggering event and then the predetermined action (to drive the toy car to move backward, namely the corresponding task) set by the character strings ifttt_android(2) is activated or enabled to drive the toy car to move backward.

There are further embodiments provided as follows.

### Embodiment 1

An application program establishing platform, which is configured to be implementable on a computer to provide a user with a user interface for establishing an application program based on a user-defined logical determining criterion and implementable on a mobile device, includes: a managing module configured to provide the user to set the user-defined logical determining criterion, wherein the user-defined logical determining criterion is based on an if-this-than-that rule, and to compile the application program into a format implementable on the mobile device.

### Embodiment 2

The platform according to Embodiment 1, the managing module is configured to provide the user to set the user-defined logical determining criterion by one of a menu-based operation and a click-based operation.

### Embodiment 3

The platform according to Embodiment 1 further includes: a compiling module configured to compile the user-defined logical determining criterion into an application program executable on a mobile device.

### Embodiment 4

The platform according to Embodiment 1, the mobile device further includes: a wireless communication module used for transmitting/receiving a wireless communication signal; a plurality of sensor modules, each of which sensor modules is used for sensing a specific triggering event and correspondingly generating a sensing signal; and an application processor receiving the sensing signal and performing the user-defined logical determining criterion, wherein the user-defined logical determining criterion is used for determining whether the sensing signal satisfies a predetermined condition, and if the sensing signal satisfies the predetermined condition, the application processor is triggered to perform a specific responding task in response to the specific triggering event.

### Embodiment 5

The platform according to Embodiment 4, the application program based on the user-defined logical determining criterion is installed in the application processor and the application processor performs the user-defined logical determining criterion through performing the application program.

### Embodiment 6

The platform according to Embodiment 4, the plurality of sensor modules are one selected from a group consisting of a motion sensor, an acceleration meter, an electronic compass, an infrared ray light emitting diode, a front camera, a main camera, an luminance sensor, a touch sensor, a global positioning system module, an image sensor, a magnetic field sensor, an orientation sensor, a proximity sensor, an near field sensor, a temperature sensor, a counter, a count-up timer, a count-down timer and a combination thereof.

### Embodiment 7

The platform according to Embodiment 1, the mobile device is one selected from a smart phone, a tablet computer, a phablet, a wearable device and a combination thereof.

### Embodiment 8

The platform according to Embodiment 1, the computer is one selected from a personal computer, a desktop computer, a notebook computer and a combination thereof.

### Embodiment 9

The platform according to Embodiment 1, the application program implementable on the mobile device is based on one selected from a geographic information system (GIS) technology, a global positioning system (GPS) technology, a location based services (LBS) technology and a combination thereof.

### Embodiment 10

The platform according to Embodiment 1, further comprising a plurality of cloud technology related services which is selected from a software as a service (SaaS) technology, a platform as a service (PaaS) technology, an infrastructure as a service (IaaS) technology and a combination thereof.

### Embodiment 11

A system of performing an application program establishing platform, by which system a user accesses the application program establishing platform having a user interface through a browser to establish an application program based on an if-this-than-that rule and implementable on a mobile device, includes: a server in which the application program establishing platform is installed; and a user end electrically connected to the server through an internet and capable of performing the browser, through which browser the user accesses the application program establishing platform, wherein the application program establishing platform comprises a managing module configured to provide the user to set up the if-this-than-that rule.

### Embodiment 12

The system according to Embodiment 11, the mobile device is one selected from a smart phone, a tablet computer, a phablet, a wearable device and a combination thereof.

### Embodiment 13

The system according to Embodiment 11, the user end is one selected from a personal computer, a desktop computer, a notebook computer and a combination thereof.

### Embodiment 14

The system according to Embodiment 11, the internet is one selected from a cable network, a wireless network, a cloud network, a local area network (LAN) or a wide area network (WAN) and a combination thereof.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. An application program establishing platform, which is configured to be implementable on a computer to provide a user with a user interface for establishing an application program based on a user-defined logical determining criterion and implementable on a mobile device, comprising:
a managing module configured to provide the user to set the user-defined logical determining criterion, wherein the user-defined logical determining criterion is based on an if-this-than-that rule, and to compile the application program into a format implementable on the mobile device.

2. The platform according to claim 1, wherein the managing module is configured to provide the user to set the user-defined logical determining criterion by one of a menu-based operation and a click-based operation.

3. The platform according to claim 1, further comprising:
a compiling module configured to compile the user-defined logical determining criterion into an application program executable on a mobile device.

4. The platform according to claim 1, wherein the mobile device further comprises:
a wireless communication module used for transmitting/receiving a wireless communication signal;
a plurality of sensor modules, each of which sensor modules is used for sensing a specific triggering event and correspondingly generating a sensing signal; and
an application processor receiving the sensing signal and performing the user-defined logical determining criterion, wherein the user-defined logical determining criterion is used for determining whether the sensing signal satisfies a predetermined condition, and if the sensing signal satisfies the predetermined condition, the application processor is triggered to perform a specific responding task in response to the specific triggering event.

5. The platform according to claim 4, wherein the application program based on the user-defined logical determining criterion is installed in the application processor and the application processor performs the user-defined logical determining criterion through performing the application program.

6. The platform according to claim 4, wherein the plurality of sensor modules are one selected from a group consisting of a motion sensor, an acceleration meter, an electronic compass, an infrared ray light emitting diode, a front camera, a main camera, an luminance sensor, a touch sensor, a global positioning system module, an image sensor, a magnetic field sensor, an orientation sensor, a proximity sensor, an near field sensor, a temperature sensor, a counter, a count-up timer, a count-down timer and a combination thereof.

7. The platform according to claim 1, wherein the mobile device is one selected from a smart phone, a tablet computer, a phablet, a wearable device and a combination thereof.

8. The platform according to claim 1, wherein the computer is one selected from a personal computer, a desktop computer, a notebook computer and a combination thereof.

9. The platform according to claim 1, wherein the application program implementable on the mobile device is based on one selected from a geographic information system (GIS) technology, a global positioning system (GPS) technology, a location based services (LBS) technology and a combination thereof.

10. The platform according to claim 1, further comprising a plurality of cloud technology related services which is selected from a software as a service (SaaS) technology, a platform as a service (PaaS) technology, an infrastructure as a service (IaaS) technology and a combination thereof.

11. A system of performing an application program establishing platform, by which system a user accesses the application program establishing platform having a user interface through a browser to establish an application program based on an if-this-than-that rule and implementable on a mobile device, comprising:
a server in which the application program establishing platform is installed; and
a user end electrically connected to the server through an internet and capable of performing the browser, through which browser the user accesses the application program establishing platform, wherein the application program establishing platform comprises a managing module configured to provide the user to set up the if-this-than-that rule.

12. The system according to claim 11, wherein the mobile device is one selected from a smart phone, a tablet computer, a phablet, a wearable device and a combination thereof.

13. The system according to claim 11, wherein the user end is one selected from a personal computer, a desktop computer, a notebook computer and a combination thereof.

14. The system according to claim 11, wherein the internet is one selected from a cable network, a wireless network, a cloud network, a local area network (LAN) or a wide area network (WAN) and a combination thereof.
